(19) United States
(12) Patent Application Publication
(10) Pub. No.: US 2012/0192149 A1
(43) Pub. Date: Jul. 26, 2012

(54) CODE GENERATION FOR REAL-TIME EVENT PROCESSING

(75) Inventors: Asaf Adi, Qiryat Ata (IL); David Botzer, Haifa (IL); Yonit Magid, Haifa (IL); David Oren, Haifa (IL); Boris Shulman, Haifa (IL)

(73) Assignee: INTERNATIONAL BUSINESS MACHINES CORPORATION, Armonk, NY (US)

(21) Appl. No.: 13/413,672

(22) Filed: Mar. 7, 2012

Related U.S. Application Data
(63) Continuation-in-part of application No. 11/688,882, filed on Mar. 21, 2007.

(51) Int. Cl. G06F 9/44

(52) U.S. Cl. 717/108

(57) ABSTRACT

A method for information processing includes defining a set of abstract operators for use in implementing computing operations, including iterative operations. Respective execution times are determined for the operations implemented by the abstract operators. Given a definition of a rule, including a complex event and an action to be performed upon occurrence of the complex event, software code to implement the rule is automatically generated by generating concrete instances of the abstract operators so as to invoke a sequence of computing steps that includes iterations of the iterative operations. A worst-case estimate of a duration of execution of the software code is computed based on the respective execution times.

### CROSS-REFERENCE TO RELATED APPLICATION

This application is a continuation-in-part of U.S. patent application Ser. No. 11/688,882, filed Mar. 21, 2007.

### COPYRIGHT NOTICE

Program listings in the disclosure of this patent document contain material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to computer systems and software, and specifically to tools and methods for programming the response of a computer system to specified events.

### BACKGROUND OF THE INVENTION

There are many applications in which a computer must detect, evaluate and respond to events. Such events may include substantially any occurrence of interest that is detected by the computer, such as a change in the price of a stock, the beginning of a banking transaction, change of an entry in a database, or a suspected fault in a computer or communication system. The timing, sequence and content of these events are generally not known in advance. Various tools have been developed in order to allow events and their attendant reactions to be specified in a general, flexible way.

For example, U.S. Pat. No. 6,604,093 describes a situation awareness system. The system uses a language that enables complex events to be defined as the composition of multiple simple events, such as successive withdrawals from one or more bank accounts. In addition, a particular order and other timing constraints on the component events may be specified. Once the complex event has been detected, there may be one or more conditions that qualify the event, for example, that the amounts of the withdrawals be greater than a specified threshold. If the conditions are satisfied, then an action is triggered, such as alerting the bank's security manager of a possible fraud.

Aspects of the situation management system described in U.S. Pat. No. 6,604,093 are implemented in IBM Active Middleware Technology™ (formerly known as AMiT), a situation management tool developed at IBM Haifa Research Laboratory (Haifa, Israel). This tool is described in an article by Adi and Etzion entitled, “AMiT—the Situation Manager,” VLDB Journal 13 (2) (Springer-Verlag, May, 2004), pages 177-203.

Some event-processing systems have real-time performance requirements that cannot always be met by conventional, general-purpose processing engines such as the one provided by IBM Active Middleware Technology. In telecommunications applications, for example, a variety of adjunct switching services such as debit-based billing, number mapping, call forwarding, and local-number portability involve event processing during the critical call-connection phase of a telephone call. To meet the real-time requirements of the network, the service time for such events generally must not exceed a few milliseconds. These limitations have led to the use of custom database systems for many high-performance real-time event processing applications.

As an alternative, U.S. Pat. No. 6,496,831 describes a general-purpose real-time event processing system (EPS), which is said to avoid the problems associated with custom systems. The EPS uses one or more real-time analysis engines (RAEs), operating in conjunction with a main-memory storage manager as its underlying database system. The main-memory storage manager offers transactional access to persistent data, but at the speed of a main-memory system. The EPS may implement a parallel arrangement of RAEs for scalability as workload and resources increase. Other real-time event processing systems are described in U.S. Pat. No. 6,449,618, U.S. Pat. No. 6,502,133, U.S. Pat. No. 6,681,230, and U.S. Pat. No. 6,968,552.

### SUMMARY OF THE INVENTION

A disclosed embodiment of the present invention provides a method for information processing. A set of abstract operators is defined for use in implementing computing operations—including iterative operations—that are associated with event processing. Respective execution times are determined in advance for the operations implemented by the abstract operators on a selected computing platform. A rule is defined as including a complex event and an action to be performed upon occurrence of the complex event. Software code is automatically generated to implement the rule on the selected computing platform by generating concrete instances of the abstract operators so as to invoke a sequence of computing steps that includes iterations of the iterative operations responsively to the occurrence of the complex event. A worst-case estimate of a duration of execution of the software code is computed based on the respective execution times of the operations in the sequence with the iterations. When the worst-case estimate is no greater than a predetermined limit, the software code may be run on the selected computing platform so as to cause the action to be performed when the rule is satisfied.

Other embodiments of the invention provide apparatus and computer software products.

The present invention will be more fully understood from the following detailed description of the embodiments thereof, taken together with the drawings in which:

### BRIEF DESCRIPTION OF THE DRAWINGS

FIG. 1 is a schematic, pictorial illustration showing a system for real-time event processing, in accordance with an embodiment of the present invention;

FIG. 2 is a flow chart that schematically illustrates a method for generating software code for real-time event processing, in accordance with an embodiment of the present invention; and

FIG. 3 is a software class diagram that schematically illustrates classes generated in a code generation process, in accordance with an embodiment of the present invention.

### DETAILED DESCRIPTION OF EMBODIMENTS

The term “real-time processing” can have different meanings in different applications. In the field of event processing, the term generally means that the event-processing system completes its handling of a given event within a short time of the occurrence of the event. Even “short” in this context is not well defined, since some real-time applications may require that events be processed within a few milliseconds of occurrence (or even less), while others require that processing be completed within seconds or even minutes of the event. What is common, however, to all of these “real-time” applications is that there is a specified time limit that the event-processing software must reliably meet. General-purpose event-processing engines, such as the above-mentioned IBM Active Middleware Technology engine, can be configured flexibly to perform a wide range of event-processing tasks, but they do not generally offer this sort of real-time performance predictability.

Embodiments of the present invention, on the other hand, provide methods and systems for automatic generation of software code for real-time event processing in which processing time for specified complex events is guaranteed to be no greater than a specified limit. This sort of system, as described in detail hereinbelow, generates code to implement declarative definitions of event processing rules that are input by a user. By analyzing the operations that the code will have to perform in processing a given rule, the code generation system is able to compute in advance a worst-case estimate of the duration of execution of the code on a given computing platform. The user can thus determine with high confidence that the real-time performance of the code will be adequate, or take corrective measures if the worst-case estimate is too high.

One of the challenges in setting reliable bounds on execution times is that software code—including code for real-time event processing—generally contains loops, which can go through many iterations in the course of execution. In an embodiment of the present invention, the code generation system addresses this challenge by identifying iterative operations invoked in implementing the rules and taking the iterations of these operations into account in computing the worst-case estimates. Specifically, the system may derive a bound on the number of iterations that will occur at run-time, and then multiply this bound by the execution time of the single iteration to generate the worst-case estimate. The system typically calculates the bound by analyzing the definition of the rule itself, which indicates the maximal number of situation components, such as simple events, that may have to be processed in detecting the occurrence of the complex event.

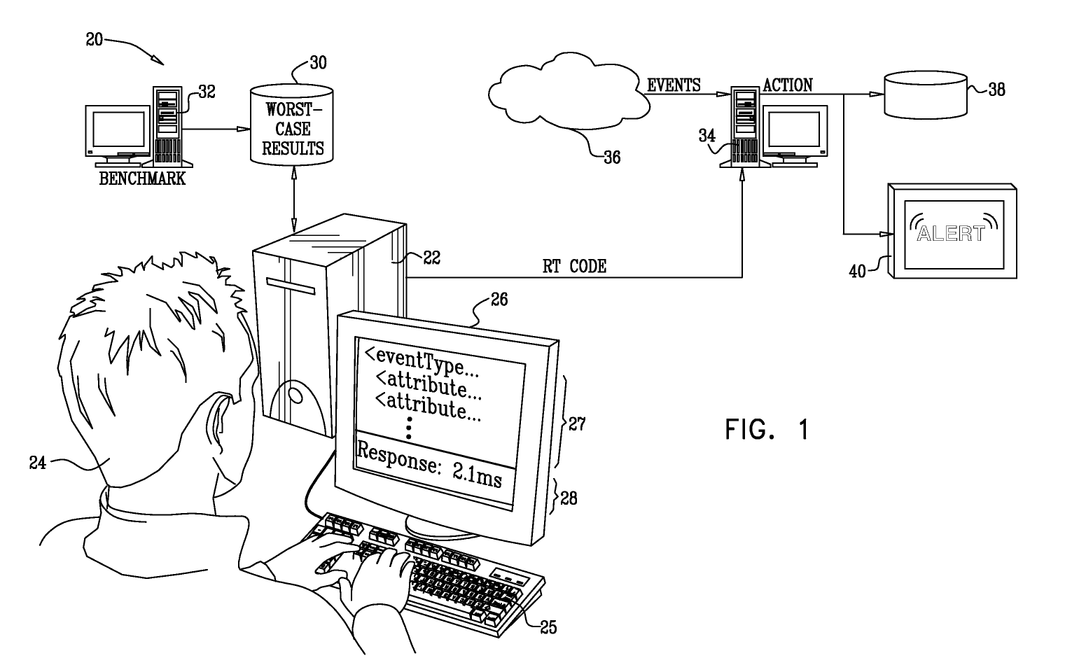

FIG. 1 is a schematic, pictorial illustration of a system 20 for real-time event processing, in accordance with an embodiment of the present invention. The system comprises a code-generation processor 22, which is operated by a user 24 to generate real-time event-processing software code. Processor 22 is typically connected to a user interface, including an input device 25, such as a keyboard, and an output device 26, such as a display monitor, through which user 24 may compose complex event processing rules 27 and receive feedback 28 regarding the worst-case execution duration of the rules. Typically, processor 22 comprises a general-purpose computer, which is programmed in software to carry out the functions described herein. This software may be downloaded to the processor in electronic form, over a network, for example, or it may alternatively be provided on tangible media, such as optical, magnetic or electronic memory.

For each rule that is defined by user 24, processor 22 determines the sequence of processing operations that will have to be performed by the corresponding software code, and then looks up the worst-case execution time for each operation in a data repository 30, such as a database. The generated code is typically not a “straight-line” sequence of steps, but rather contains iterations. Processor 22 predicts a worst-case bound on the number of the iterations and can thus calculate the worst-case bound for the entire execution based on the repository of execution times for basic operations.

Typically, these execution times are measured in advance for each type of operation by running benchmark execution tests on a test platform 32, using methods of benchmarking that are known in the art. Alternatively, execution times of simple, straight-line program building blocks (such as single-line commands) may be calculated using methods of modeling that are known in the art, as described, for example, by Harmon et al., in “A Retargetable Technique for Predicting Execution Time of Code Segments,” IEEE Real-Time Systems Symposium (1992), pages 69-77, whose disclosure is incorporated herein by reference. The execution time for each type of operation depends, of course, on the computing platform on which the software is to execute. Therefore, for each type of operation, repository 30 may contain worst-case estimates with respect to a number of different platforms. Processor 22 may thus compute and inform user 24 of the worst-case execution times for a given rule on two or more different platforms, thus enabling the user to choose a more powerful platform if necessary to meet the real-time system requirements.

Processor 22 generates real-time software code to implement rules 27 that are input by user 24. In an exemplary embodiment, which is described in greater detail hereinbelow, the user inputs the rules in the form of declarative statements. Processor 22 translates these statements into corresponding software classes, which inherit from a predefined set of abstract classes. The rule syntax and abstract classes may be designed specifically for efficient, predictable execution, by limiting the number and/or lifespans of events that may be included in a rule, for example, and limiting access to non-real-time external resources, such as large databases.

When code generation is complete, and user 24 has determined that the worst-case execution time is within acceptable limits, the run-time code is compiled and loaded into an execution platform 34. This platform typically comprises a general- or special-purpose computer, with an interface for receiving indications of events from a source or set of sources 36. (Sources 36 are represented in FIG. 1 as a network, which is the origin of events in many telecommunications and computing applications, but platform 34 may receive event indications from sources of substantially any type.) Platform 34 compares each event to the set of rules embodied in the run-time code, in order to detect occurrence of the complex events that are defined by the rules. When a given rule is satisfied, platform 34 triggers performance of an action, such as writing a record to a memory 38, outputting an alert via a user interface device 40, actuating an item of machinery (not shown), or substantially any other action appropriate to the system requirements.

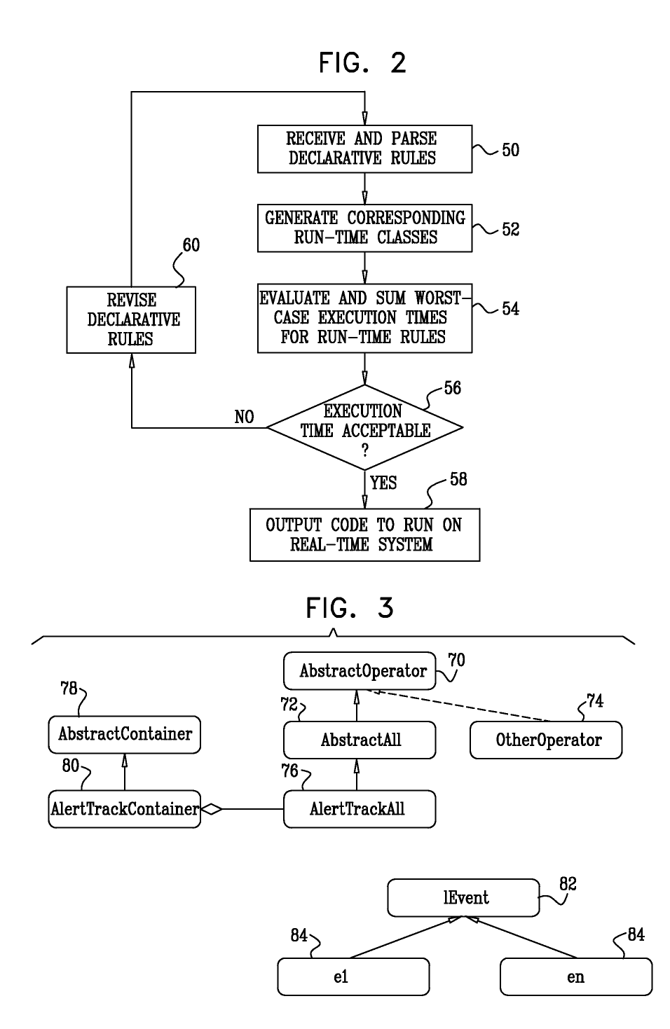

FIG. 2 is a flow chart that schematically illustrates a method for automatic generation of software code for real-time event processing, in accordance with an embodiment of the present invention. At the initiation of the method, processor 22 receives and parses one or more complex event processing rules that are input by user 24, at a rule input step 50. As noted above, the user typically inputs the rules in a declarative language, based on a predefined syntax. For example, the rules may be written in Extensible Markup Language (XML) using a suitable schema. A simple rule of this sort is shown below in Table I:

TABLE I
RULE DEFINITION

```
  − <domain>
  − <eventTypes>
```

− <eventType name=“AlertTrigger” updateDefinition=“add”>

<attributeType name=“trackId” xsi:type=“integer” />

</eventType>

− <eventType name=“TrackData” updateDefinition=“add”>

<attributeType name=“trackId” xsi:type=“integer” />
<attributeType name=“x” xsi:type=“integer” />
<attributeType name=“y” xsi:type=“integer” />

</eventType>

− <eventType name=“AlertTrack” updateDefinition=“add”>

<attributeType name=“trackId” xsi:type=“integer” />
<attributeType name=“x” xsi:type=“integer” />
<attributeType name=“y” xsi:type=“integer” />

</eventType>

</eventTypes>

</domain>

− <rules>

− <situations>

− <situation name=“AlertTrack” updateDefinition=“add”>

```
  − <all detectionMode=“immediate”
  repeatMode=“always”>
```

<operandAll eventType=“AlertTrigger”

necessity=“1” override=“false”
quantifier=“first” quantifierType=“relative”
retain=“false” threshold=“” />

<operandAll eventType=“TrackData” necessity=“1”

override=“false” quantifier=“first”
quantifierType=“relative” retain=“false”
threshold=“” />

```
</all>
<situationAttribute attributeName=“trackId”
  expression=“TrackData.trackId” />
<situationAttribute attributeName=“x”
  expression=“TrackData.x” />
<situationAttribute attributeName=“y”
  expression=“TrackData.y” />
```

</situation>

</situations>

</rules>

</amt>

The sample code above defines a “situation,” which is a complex event, defined as a composition of other simple or complex events together with conditions attached to these events. The situation in this case, called AlertTrack, is an “all” situation over two component events, TrackData and AlertTrigger, meaning that both of the component events must occur in order for the situation (and the corresponding rule) to be triggered. The two events in the situation use an arbitrary quantifier, referred to as “first,” and have the “retain” attribute set to “false,” meaning that the events are not to be retained by execution platform 34 after situation detection.

Processor 22 parses the rules defined by the user and generates corresponding run-time software code, at a code generation step 52. The processor also evaluates the worst-case execution duration for the code and presents the result to user 24, at an execution time computation step 54. For the sake of convenience and clarity of explanation, step 54 is shown in the figure and described hereinbelow as following step 52 (since the total execution duration depends on the benchmarked times that will be required to perform each of the operations in the run-time code). In practice, however, as will be explained below, each element of the situation expressed in the declarative language corresponds to certain operations in predefined abstract software classes. Thus, processor 22 may alternatively associate respective execution times with the expressions in the declarative language, and may use these execution times in computing the worst-case execution duration directly, before actually generating any code.

FIG. 3 is a software class diagram that schematically illustrates classes that are generated at step 52, in accordance with an embodiment of the present invention. Operators that may be used in event processing (such as the “all” operator in AlertTrack) are expressed as concrete sub-classes of a corresponding abstract base class, which in turn inherits from a generic abstract operator class 70. Thus, as shown in the figure, an AbstractAll class 72, as well as other abstract operator classes 74, inherit from class 70. Processor 22 derives a concrete AlertTrackAll class 76 from class 72 in order to implement the specific attributes of the AlertTrack situation.

Processor 22 also generates a container 80 for holding sets of instances of each operator, which inherits from an abstract container class 78. Container 80 holds all active lifespans relating to the situation defined by the corresponding concrete class, and routes incoming events to the appropriate situation objects. For this purpose, for example, if the AlertTrackAll situation may be keyed using an ID attribute, it will ensure that the relevant incoming events are routed to an AlertTrackAll object with matching ID.

Events 84 are likewise defined as concrete classes, which implement an interface inherited from an abstract IEvent class 82.

The chain of inheritance of AlertTrackAll is shown by way of example in Tables II, III and IV in the Appendix below. The sample programs shown are written in the Java™ language, but the principles of the present invention may similarly be implemented in other suitable programming languages, as will be apparent to those skilled in the art. AlertTrackAll in Table IV inherits from AbstractAll in Table III, which in turn inherits from AbstractOperator in Table II. These classes import other classes for operations such as adding, composing and consuming events, which are omitted here for the sake of brevity. Such operations are commonly used in event processing, and their implementation will be apparent to those skilled in the art.

The code in Tables II and III contains iterative operations, such as the loops that are introduced by the following “FOR” statements:
In Table II—“for (int i=0; i<consumers.length; ++i) . . . ”
In Table III—
   “for (int i=0; i<composers.length; ++i) . . . ”
   “for (int i=0; i<candidates.length; ++i) . . . ”
   “for (int i=0; i<total; ++i) . . . ”
      The “length” in each of the statements above determines the number of iterations that will be traversed in actual execution of the code. The actual value of the length parameter is determined in each case by the rule definition that invokes the iterative operation, such as by the maximum number of situation operands (simple events) that may participate in a given complex event. In the simple example that is shown in Table IV, the number of such events is two, but in practice the count may be much more complex. For example, the “candidates” loop in Table III contains nested iterations.

Processor 22 maps the expressions in the declarative rule definition in Table I above to corresponding operations in AlertTrackAll. Since the AlertTrack situation is an “all” situation over two event types, the AlertTrackAll class extends AbstractAll, as explained above, and the “candidates” field in AltertTrackAll is an array of size 2, with two add methods, one for each event type. Because the two events in Table I use the “first” quantifier (an arbitrary attribute, used here for the sake of illustration), the corresponding adder and composer code objects are of the type FirstEventAdder and FirstEventComposer, which mimic the behavior of the “first” quantifier. An EventConsumer is included in the generated code to delete the events that were used to detect the situation, since the retain=“false” attribute indicates that the events are not to be retained after situation detection.

Returning now to FIG. 2, at step 54 processor 22 analyzes the run-time code corresponding to each rule input by user 24 in order to estimate the worst-case execution time for the rule. As noted above, this estimate is based on benchmarks stored in repository 30 for platform 34. The benchmarks typically assume that platform 34 will run a real-time implementation of the programming language in question, such as Java, i.e., an implementation with guaranteed execution time for primitive operations, such as memory allocation.

To derive the worst-case time estimate, processor 22 analyzes the basic behavior of the operators in the run-time code, such as the “compose” method in AbstractAll, and the “consume” method in AbstractOperator, as shown in Tables II and III below. The execution times of these operators will depend, in turn on the number of candidate events that are kept in memory, as well as on the execution times of the various event adders (such as FirstEventAdder), composers (such as FirstEventComposer), and consumers. These execution times may all be benchmarked in advance.

For iterative operations, processor 22 derive a bound on the number of iterations that will occur at run time, and multiplies this bound by the known execution time of a single iteration of the operation. The bound is typically derived by the processor by analyzing the definition of the rule itself in order to find a maximal number of situation components, which gives the bound on the number of iterations. For example, the rule may indicate the maximal number of simple events that will need to be processed by the software code in detecting an occurrence of the complex event that is the subject of the rule. Other examples of situation components from which the bound may be derived include the number of simultaneously open lifespans and the maximal number of event candidates (i.e., instances) for each event operand type.

In addition, processor 22 analyzes the execution times of rule-specific operations, such as the “createNotification” method in the AlertTrackAll class in Table IV. The createNotification method, for example, is composed of low-level Java primitives (array access, expression evaluation, etc.), which are also benchmarked in advance. The processor uses these benchmarks in computing the worst-case estimate for the specific method.

After having broken down the code (or possibly the corresponding declarative expressions, as explained above) into primitives and other operations that have been benchmarked in advance, processor 22 adds up the worst-case benchmark execution times for these primitives and operations (with multiplication as necessary for iterative operations) to get the total execution duration for the entire rule. For instance the createNotification method in AlertTrackAll (Table IV) consists of two array access operations, creation of a new object, and setting the values of three variables. The worst-case execution times of these primitives are summed to give the worst-case time that will be required to create a notification of a detected situation. Worst-case execution times for the other operations in AlertTrackAll may be determined in like manner.

The processor typically presents the result of the execution duration computation to the user on output device 26, at an acceptance step 56. If the user determines that the worst-case duration is within the acceptable limit to meet the real-time requirements of the application in question, the user approves the code. In this case, processor 22 outputs the code to run on platform 34 (typically after having compiled the source code into byte code or other executable form).

Alternatively, if the execution duration is longer than acceptable, user 24 may make appropriate changes in order to meet real-time requirements. For example, the user may simplify or otherwise revise the rules for faster operation, at a rule revision step 60. Processor 22 receives the revised rules at step 50 and repeats steps 52-56 in order to present the user with the new execution duration. As another alternative, the user may instruct the processor to repeat the computation of execution duration for a more powerful real-time platform, which will presumably run the code faster. Once the user has reached an acceptable result, the processor outputs the code at step 58.

Although the embodiments described above relate specifically to event processing, the principles of the present invention may similarly be applied in real-time applications of other types. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### APPENDIX—JAVA CLASSES

TABLE II
ABSTRACT OPERATOR CLASS

abstract public class AbstractOperator {

protected CyclicList[ ] candidates;
protected IEventAdder[ ] adders;
protected IEventComposer[ ] composers;
protected IEventConsumer[ ] consumers;
abstract protected IEvent[ ] compose( );
abstract protected IEvent

createNotification(IEvent[ ] events);

abstract protected IEvent[ ] createSituationArray(int

size);

protected void consume( ) {

for (int i = 0; i < consumers.length; ++i) {

consumers[i].consumeEvents( );

}

}

}

TABLE III
ABSTRACT ALL CLASS

abstract public class AbstractAll extends AbstractOperator {
protected IEvent[ ] compose( ) {

```
int total = 1;
for (int i = 0; i < composers.length; ++i) {
  int count = composers[i] .getCount( );
  if (count == 0)
```

return null;

```
  total *= count;
}
int currentTotal = total;
IEvent[ ][ ] matrix = new
  IEvent[total][candidates.length];
for (int i = 0; i < candidates.length; ++i) {
  //if (each[i]) {
```

```
int copyCount = currentTotal /
  composers[i].getCount( );
currentTotal /=
  composers[i].getCount( );
int row = 0;
while (row < total) {
```

for (int j = 0; j <
composers[i].getCount( ); ++j)

for (int l = 0; l <
copyCount; ++l) {

```
matrix[row++][i] =
  composers[i].get(j);
composers[i].get (j).
  setComposed(true);
```

}

}

}
IEvent notifications[ ] = createSituationArray(total);
for (int i = 0; i < total; ++i) {
notifications [i] = createNotification(matrix[i]);
}
consume( );
return notifications;

}
}

TABLE IV
ALERT TRACK ALL

In order to generate the AlertTrackAll class, an

```
  add( ) method is generated for each participating event.
  The array size (two in this case) is determined by the
  number of participating events.
public class AlertTrackAll extends AbstractAll {
  public AlertTrackAll( ) {
```

candidates = new CyclicList[2];
candidates[0] = new CyclicList( );
candidates[1] = new CyclicList( );
adders = new IEventAdder[2];
adders[0] = new FirstEventAdder(candidates[0]);
adders[1] = new FirstEventAdder(candidates[1]);
composers = new IEventComposer[2];
composers[0] = new FirstEventComposer(candidates[0]);
composers[1] = new FirstEventComposer(candidates[1]);
consumers = new IEventConsumer[2];
consumers[0] = new EventConsumer(candidates[0]);
consumers[1] = new EventConsumer(candidates[1]);

```
  }
  public void add(TrackData td) {
```

adders[0].addEvent(td);

```
  }
  public void add(AlertTrigger at) {
```

adders[1].addEvent(at);

```
  }
  protected IEvent createNotification(IEvent[ ] events) {
```

TrackData td = (TrackData) events[0];
AlertTrigger at = (AlertTrigger) events[1];
AlertTrack track = new AlertTrack( );
track.trackId = td.trackId;
track.x = td.x;
track.y = td.y;
return track;

```
  }
  protected IEvent[ ] createSituationArray(int size) {
```

return new AlertTrack[size];

}
}

1. A method for information processing, comprising:
defining a set of abstract operators for use in implementing computing operations associated with event processing, the computing operations including iterative operations;
determining in advance respective execution times for the operations implemented by the abstract operators on a selected computing platform;
receiving a definition of a rule comprising a complex event and an action to be performed upon occurrence of the complex event;
automatically generating software code to implement the rule on the selected computing platform by generating concrete instances of the abstract operators so as to invoke a sequence of computing steps that includes iterations of the iterative operations responsively to the occurrence of the complex event;
computing a worst-case estimate of a duration of execution of the software code based on the respective execution times of the operations in the sequence with the iterations; and
when the worst-case estimate is no greater than a predetermined limit, running the software code on the selected computing platform so as to cause the action to be performed when the rule is satisfied.

2. The method according to claim 1, wherein receiving the definition comprises receiving a set of expressions in a declarative language, wherein determining the respective execution times comprises storing benchmark times for the expressions in the declarative language in a repository prior to receiving the definition of the rule, wherein computing the worst-case estimate comprises reading the benchmark times from the repository, and wherein automatically generating the software code comprises generating run-time code that implements the expressions.

3. The method according to claim 1, wherein the set of the abstract operators comprises first software classes, and wherein generating the software code comprises generating the concrete instances of the abstract operators by defining second software classes by inheritance from the first software classes.

4. The method according to claim 1, wherein determining the respective execution times comprises finding an execution time of a single iteration of an iterative operation, and wherein computing the worst-case estimate comprises deriving a bound on a number of the iterations of the iterative operation that will occur at run-time, and multiplying the bound by the execution time of the single iteration to generate the worst-case estimate.

5. The method according to claim 4, where setting the bound comprises calculating the bound by analyzing the definition of the rule.

6. The method according to claim 5, wherein analyzing the definition comprises finding a maximal number of situation components to be processed by the software code in detecting the occurrence of the complex event, and setting the bound responsively to the maximal number.

7. Apparatus for information processing, comprising:
a memory, which is arranged to store a definition of a set of abstract operators for use in implementing computing operations associated with event processing, the computing operations including iterative operations, and respective execution times for the operations implemented by the abstract operators on a selected computing platform; and
a code processor, which is arranged to receive a definition of a rule comprising a complex event and an action to be performed upon occurrence of the complex event, and to automatically generate software code to implement the rule on the selected computing platform by generating concrete instances of the abstract operators so as to invoke a sequence of computing steps that includes iterations of the iterative operations responsively to the occurrence of the complex event and to compute a worst-case estimate of a duration of execution of the software code based on the respective execution times of the operations in the sequence with the iterations, such that when the worst-case estimate is no greater than a predetermined limit, the code processor outputs the software code to run on the selected computing platform so as to cause the action to be performed when the rule is satisfied.

8. The apparatus according to claim 7, wherein the code processor is arranged to receive the definition of the rule as a set of expressions in a declarative language, wherein the respective execution times comprise benchmark times for the expressions in the declarative language, which are stored in the memory prior to receiving the definition of the rule, and wherein the code processor is arranged to generate run-time code that implements the expressions.

9. The apparatus according to claim 7, wherein the set of the abstract operators comprises first software classes, and wherein the code processor is arranged to generate the concrete instances of the abstract operators by defining second software classes by inheritance from the first software classes.

10. The apparatus according to claim 7, wherein the respective execution times comprise an execution time of a single iteration of an iterative operation, and wherein the code processor is configured to derive a bound on a number of the iterations of the iterative operation that will occur at run-time, and to multiply the bound by the execution time of the single iteration to generate the worst-case estimate.

11. The apparatus according to claim 10, where the code processor is configured to calculate the bound by analyzing the definition of the rule.

12. The apparatus according to claim 10, wherein the code processor is configured to find a maximal number of situation components to be processed by the software code in detecting the occurrence of the complex event, and to set the bound responsively to the maximal number.

13. A computer software product, comprising a tangible computer-readable medium in which program instructions are stored, which instructions, when read by a computer, cause the computer to read from a memory a definition of a set of abstract operators for use in implementing computing operations associated with event processing, the computing operations including iterative operations, and respective execution times for the operations implemented by the abstract operators on a selected computing platform, and to receive a definition of a rule comprising a complex event and an action to be performed upon occurrence of the complex event, and to automatically generate software code to implement the rule on the selected computing platform by generating concrete instances of the abstract operators so as to invoke a sequence of computing steps that includes iterations of the iterative operations responsively to the occurrence of the complex event and to compute a worst-case estimate of a duration of execution of the software code based on the respective execution times of the operations in the sequence with the iterations, such that when the worst-case estimate is no greater than a predetermined limit, the computer outputs the software code to run on the selected computing platform so as to cause the action to be performed when the rule is satisfied.

14. The product according to claim 13, wherein the instructions cause the computer to receive the definition of the rule as a set of expressions in a declarative language, wherein the respective execution times comprise benchmark times for the expressions in the declarative language, which are stored in the memory before the computer receives the definition of the rule, and wherein the instructions cause the computer to generate run-time code that implements the expressions.

15. The product according to claim 13, wherein the set of the abstract operators comprises first software classes, and wherein the instructions cause the computer to generate the concrete instances of the abstract operators by defining second software classes by inheritance from the first software classes.

16. The product according to claim 13, wherein the respective execution times comprise an execution time of a single iteration of an iterative operation, and wherein the instructions cause the computer to derive a bound on a number of the iterations of the iterative operation that will occur at run-time, and to multiply the bound by the execution time of the single iteration to generate the worst-case estimate.

17. The product according to claim 16, where the instructions cause the computer to calculate the bound by analyzing the definition of the rule.

18. The product according to claim 16, wherein the instructions cause the computer to find a maximal number of situation components to be processed by the software code in detecting the occurrence of the complex event, and to set the bound responsively to the maximal number.
